(19) United States
(12) Patent Application Publication
(10) Pub. No.: US 2006/0289179 A1
(43) Pub. Date: Dec. 28, 2006

(54) Three-point universal hitch having an electric motor powered linear actuated screw drive

(76) Inventors: Nathan Irvin JR., Rio Linda, CA (US); Ronald J. Retterer, Citrus Heights, CA (US)

Correspondence Address: Donald W. Meeker;Patent Agent, 924 East Oceanfront #E, Newport Beach, CA, 92661, US

(21) Appl. No.: 11/166,750

(22) Filed: Jun. 24, 2005

(51) Int. Cl. A01B 63/118

(52) U.S. Cl. 172/448

(57) ABSTRACT

An electric motor powered linear screw drive actuator works a three point hitch attachable to a small work vehicle, such as small tractors, riding mowers, RTVs, ATVs, garden tractors, smaller four wheeled vehicles, and rigid platforms. The electric motor is powered by the vehicle electrical system. Working devices, such as a box scraper, attached to the hitch may have an additional linear screw drive actuator to actuate scraper blades or other working elements. The hitch system provides controllable upward and downward force, and enables ease of attachment and detachment for a wide range of applications and attachments that creates year-round utility of a vehicle.

### BACKGROUND OF THE INVENTION

1. Field of the Invention

The present invention relates to three-point hitches and particularly to a universal three-point hitch that raises and lowers attachments through use of an electric motor powered linear actuated screw drive.

2. Description of the Prior Art

Various systems have been used in the past for attaching farm implements to tractors. Generally these systems have been made for use on extremely large tractors and required large horsepower and hydraulic systems. A few devices have been made to be used on all terrain vehicles (ATV's), garden tractors or other light tractors. None of the prior art devices provide an electric motor powered screw drive on a three-point universal hitch having a unique design allowing ease of attachment and detachment as well as creating a controlled force upward and downward.

U.S. Pat. No. 5,697,454, issued Dec. 16, 1997 to Wilcox, provides a hitch assembly for use with endless track land vehicles, which allows an implement mounted by a three-point hitch arrangement up to about 15 degrees arcing movement off the longitudinal axis oriented in the direction of travel of the land vehicle. A pivotal mounting means is connected to two horizontal arms which are joined at the rear by another member. The mounting means and connecting arms form a four-sided polygonal structure which can be raised or lowered by a hydraulic ram since the arms are pivotally connected at the corners. Finally, a telescoping linkage assembly, after the hitch assembly has been raised through 75 percent of its travel, urges the implement mounting means on the rear vertical connecting arm into a common, pre-selected travel position.

U.S. Pat. No. 5,746,275, issued May 5, 1998 to Cross, is for a three-point hitch for an all terrain vehicle (ATV) comprising a mounting frame which is attached to the axle housing of the ATV. The mounting frame is supported on the tongue hitch of the ATV and is attached to the body of the ATV so that the rear suspension of the ATV is locked-out. The multiple-point hitch is operatively secured to the mounting frame and is raised and lowered by means of an electromechanical screw actuator. The multiple-points of the hitch are free to float, in some situations, with respect to the mounting frame and the ATV.

U.S. Pat. No. 3,561,789, issued Feb. 9, 1971 to Stikeleather, claims a powered three-point hitch carrying a hitch adapter for quick hitching to an implement. The three-point hitch is powered by any suitable means, such as a hydraulic cylinder or an electric motor configuration, to provide horizontal and vertical movement of the hitch adapter.

U.S. Pat. No. 3,850,450, issued Nov. 26, 1974 to Hadskey, describes a three-point hitch system having a top link apparatus which includes a hydraulic motor for rotating a screw which varies the length of the link, thereby adjusting the implement in relation to the tractor.

U.S. Pat. No. 4,386,662, issued Jun. 7, 1983 to Kalif, discloses a leveler frame that is attached to the three-point linkage of an agricultural tractor and serves to break up earth clods by vibrating action of its inclined blades. The implement comprises two lateral members and three cross members in the shape of one fixed inclined blade at the rear end of the frame and two vibrating blades pivotally fastened to the lateral members, one at the front end and one in the center of the frame. The pivoted blade at the front end is rigidly connected to an upstanding lever member, which serves to attach the leveler frame to the parallel upper and lower linkage arms by means of vertically spaced pivots on the lever member. The second vibratory, pivoted blade—which is not obligatory—is connected to the upstanding lever by a link extending parallel to the lateral members. During travel of the tractor across a roughly plowed field the frame is trailed behind by the freely swinging linkage arms; while the tractor wheels rise and drop alternately while passing over the uneven ground, they actuate the pivoted blade or blades by movement of the linkage arms, whereby earth clods are comminuted and the soil surface is smoothed. The single upper arm is, in addition, provided with a screw coupling and corresponding right-hand and left-hand screw-thread, which permit altering the length of the arm and, thereby, the position of the lever member. A bar is pivotally attached to the rear of the leveler frame by a pin and to the top of the lever member by a mechanism which permits both swiveling action and adjustment of the length of this bar. This mechanism consists of a bush held in the top portion by two pins which allows its oscillation about these pins. The end of the bar is screw threaded and is inserted in a threaded sleeve, the latter being slidingly and rotatably positioned in the bush, to be rotated by a crank handle. Rotation of the crank moves the sleeve in axial direction within the bush, thus shortening or lengthening the distance between the crank end and the rear end of the bar for the purpose of lifting off the leveler frame the ground by operation of the crank.

U.S. Pat. No. 3,432,184, issued Mar. 11, 1969 to Tweedy, indicates a mechanism for hitching an implement to a tractor, which has power driven actuators attached to the tractor and to a coupling plate. Several of the actuators are driven electrically and have reversible electric motors mounted on their exterior.

U.S. Pat. No. 3,990,723, issued Nov. 9, 1976 to Sessions, shows a hydraulic lift system for garden tractors. A mechanism is provided for the positioning of an implement attached to a small garden tractor which includes a power takeoff system from the engine of the tractor connected to a device that controls a power drive mechanism attached to a positioning linkage that connects with the conventional manual lifting system for such tractors. Alternately, an electromechanical system may be utilized in which an electric motor is provided with gears. Such gears are connected to a rod or lever which is attached to the bracket. Thus, movement of the motor shaft and gears in one direction causes positioning mechanism to lower implement and movement of the gears in the reverse direction raises implement.

U.S. Pat. No. 6,308,785, issued Oct. 30, 2001 to Rhoden, is for an adjustable grader-spreader bar with a three-point hitch which has a blade frame assembly comprised of a plurality of blade frames, each blade frame having a blade edge fastened at the bottom. The blade frames are slideably connected so that the blade frames have an adjustable overlap. Actuating devices, such as hydraulic rams, are used to extend or retract the blade frames, so that the width of the of the adjustable grader-spreader bar may either be increased or decreased as required for the particular application. Ground engaging skids are attached to each side of the blade frame assembly. The vertical position of each ground engaging skid may be adjusted to raise or lower each side of the adjustable grader-spreader bar. Actuating devices, such as electrical motors, are used to change the vertical position of the ground engaging skids.

What is needed is a universal three-point hitch that raises and lowers attachments through use of an electric motor powered linear actuated screw drive on smaller tractors and ATVs.

### SUMMARY OF THE INVENTION

An object of the present invention is to provide a universal three-point hitch that permits ease of attachment and detachment of accessory equipment and additionally raises and lowers attachments providing a controlled upward and downward force through use of an electric motor powered linear actuated screw drive on a rider mower, small garden tractor, or ATV for a less expensive alternative to a hydraulic drive used on large tractors.

Another object of the present invention is to create a universal hitch design that works with a range of mounting plate attachments.

A further object of the present invention is to provide retrofit accessories to riding mowers or garden tractors that do not require the disconnect of the lawn mowing mechanism to achieve use of its year round multiple applications.

One more object of the present invention is to provide a hitch that operates easily attachable accessories, using a low voltage system electrical system of mounted device/vehicle, such as a 12 volt battery system, and a low amperage draw.

Still another object of the present invention is to create a quick and easy connect and disconnect of the hitch of the present invention or its accessories through the removal or placement of only a few pins.

Yet another object of the present invention is to provide a powered hitch mechanism whose universal design enables accessory versatility for year-round multiple applications.

An additional object of the present invention is to create a mechanism and accessories that can be manufactured at a modest dollar cost.

A further additional object of the present invention is to create a mechanism that can be fabricated as original equipment or retrofitted to existing customer equipment.

Yet one more object of the present invention is to create a mechanism that can be economic, useful and versatile in its utility with gardening, farming, construction, lawn care, landscaping, roadwork, and pathway.

In brief, the device of the present invention is a three-point hitch and electric powered linear actuator mechanism that is readily mounted or easily retrofitted to small tractors, riding mowers, ATVs, vehicles and rigid platforms. The present invention mechanism, systems, and accessory attachments are designed to connect and disconnect easily in such a way that allows a range of controlled forces that push and pull, raise and lower and create a range of motions for various applications that include:
Move, grade and level material
Thatch and aerate soil
Plow, rip or roto-till soil
Transport tools or materials

The present invention provides an electric motor powered linear actuated screw drive universal hitch which can be powered from any electrical system above 12 horsepower and used to control the incremental raising or lowering of an applied force up to 500 pounds or more. The hitch can be connected to equipment by a 3 point pin mounting. Its initial market for retrofit or OEM are RTV, ATV, rider mower, garden tractor, or smaller tractors.

The present invention creates up to a 500 or greater pound force that creates applied force upward or downward. It can be used to operate customized attachments for construction, roads, gardens and lawns for soil/debris removal, scraping, disking, plowing, hauling, ripping, grading, tilling or aeration. It can be used for soil or snow in all weather conditions. The range of attachments and their functionality extend outdoor uses to four seasons for soil and snow. It eliminates the need for expensive attachments that are hydraulic systems that are over four times more costly. It does not require removal of hydraulic lawn mowing attachments for riding mowers or garden tractors to operate and use this system. Users include homeowners, gardeners, farmers, nurseries, contractors and construction companies.

The present invention is relatively simple to build and attach to a user's equipment. The use of low power inexpensive linear actuators housed in a unique structural shape creates functional mechanical movements for attachments. It exhibits a simplicity of design and economic cost. The present invention creates and achieves user-friendly, functional, economic and application benefits heretofore not experienced by low power electromechanical applications, particularly for smaller four-wheeled equipment and vehicles.

A present invention attachable device to the linear actuated screw drive comprises a box scraper with a mount for attachment to a lawn and garden tractor. The mount will allow other items such as a digger bar to be attached. The unique and essential part of the mount is the use of an electric powered screw to raise and lower the scraper or other attachment. The mount is attached by a quick pin release to the back of a tractor. The electric powered screw with controls are wired to the tractors electrical system for power. The control is a three position double throw switch 18 which will cause the screw to actuate to raise or lower the mount and automatically return the switch to the neutral position.

The box scraper has a blade which cuts when the tractor is moving in a forward direction. The side panels will hold the removed material in a position in front of the scraper. This will allow the material to be moved to a different location without spilling off the side of the blade.

There is a second blade on the scraper facing in the opposite direction which will cut when the tractor is moving in reverse. This blade can be used to dig and pile up material. There is an adjustment bar on the scraper unit which will allow the scraper blade to be at different angles to the surface being worked; this can be fitted with a second electric drive screw. There are other manual adjustments on the mount to allow different positions when hooking up to other accessories.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the universal three-point hitch of the present invention using an electric motor powered linear actuated screw drive;

FIG. 2 is a side elevational view of a plow application having an electric motor powered linear actuated screw drive attached to the universal three-point hitch of the present invention.

### BEST MODE FOR CARRYING OUT THE INVENTION

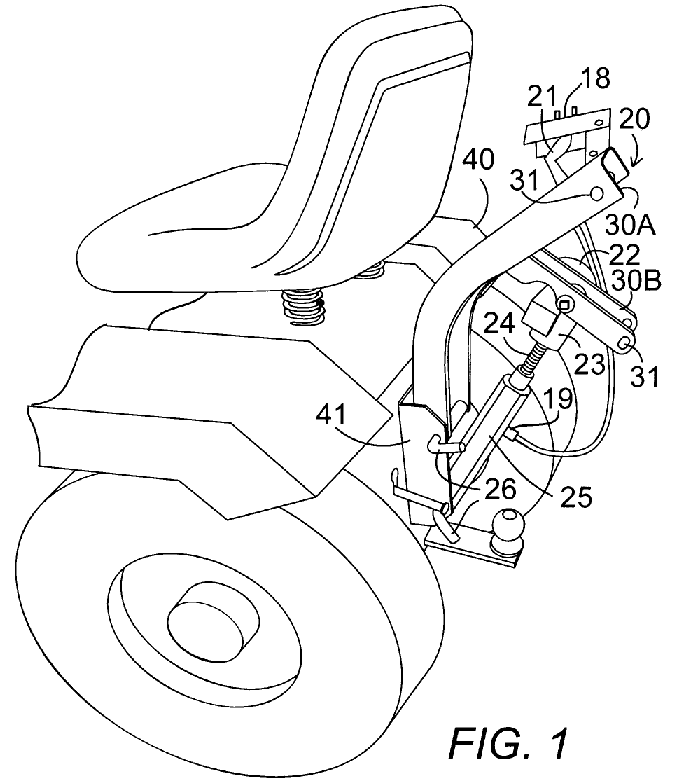

In FIG. 1, a linear actuated screw drive 24 and 25 powered by an electric motor 23 operates a universal three-point hitch device 20 that removably attaches to small working vehicles, such as a small tractor or garden tractor 40 and raises and lowers attachment implements.

The three-point universal hitch 20 utilizes a pivotable means of attaching the universal hitch to a working vehicle, such as a series of pins 26 removably insertable through mating openings 31 in the device 20 and the work vehicle 40 so that the device may be attached to and removed from the work vehicle as desired. The linear actuating mechanism has a screw drive with a threaded screw shaft 24 moving in and out of a threaded sleeve 25 powered by an electric motor 23 plugged into the vehicle electrical system by a plug connector 19. Working implements are attachable to the three-point universal hitch in such a way that the device provides a range of forces that push and pull, raise and lower and create a range of motions for various attached working implements used in various applications.

The device is structured to attach removably to any of a number of work vehicles taken from a list of work vehicles including small tractors, rider mowers, RTVs, ATVs, garden tractors, small four wheeled vehicles, and rigid platforms.

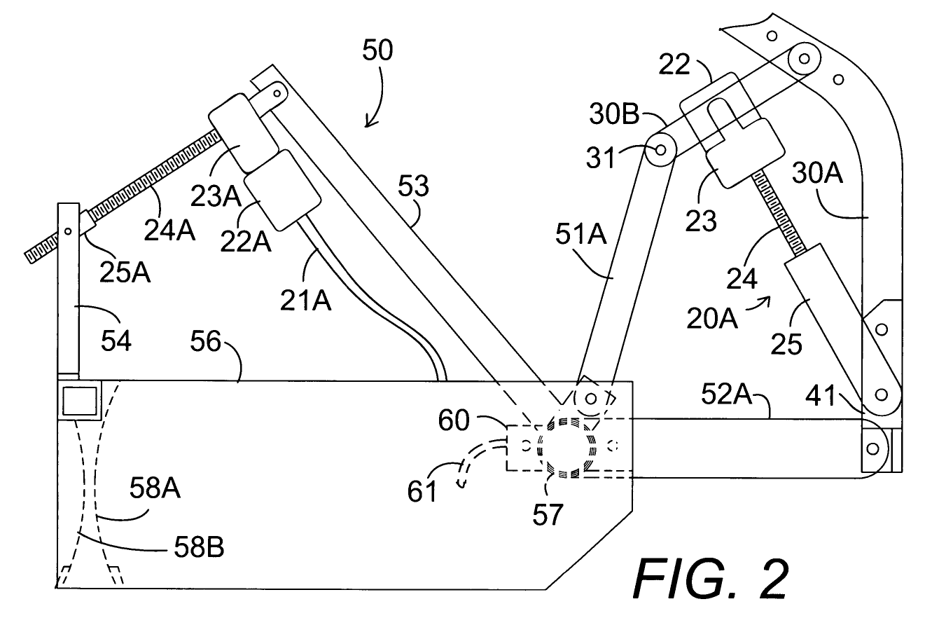

In FIG. 2, the electric powered screw drive 24 and 25 is attached to a box scraper 50 comprising a similar three-point mount with arms 30A, 30B 51A and 52A for attachment to a bracket 41 of a small working vehicle. The mount has a pivotable controlled attaching hub 57 means for attaching other work elements to the box scraper, such as a ripper bar 60 attached horizontally to the box scraper with a series of prongs 61 attached along a length of the ripper bar so that the series of prongs are used for digging in a lowered position.

The electric powered screw drive 24 and 25 raises and lowers the box scraper 50 and any other attached work tool. A box scraper control 22A for the electric powered screw is wired to an electrical system of the small working vehicle for power. A first scraper blade 58A attached horizontally across the box scraper cuts when the working vehicle is moving in a forward direction. A pair of side panels 56 hold removed material in a position in front of the first scraper blade to retain and relocate the removed material. A second scraper blade 58B is attached horizontally across the box scraper facing in an opposite direction to the first scraper blade so that the second scraper blade will cut when the working vehicle is moving in a reverse direction to dig and pile up material. A fixed bar 54 on the box scraper enables adjustment of the scraper blades to different angles to a surface being worked. A second electric motor 23A and second screw drive 24A and 25A are attached to the fixed bar 54 and an attaching bar 53 for actuating the scraper blades 58A and 58B.

A box scraper control 22 comprises a three position switch causing the screw 24 to actuate to raise or lower the mount arms and automatically return the switch to a neutral position.

Manual adjustments on the mount, such as the pins 26 of FIG. 1, to allow ease of mount removal. In FIG. 2, the plow application can be easily detached to allow mounting of other accessories that have applications to plow, thatch, grade or transport using a similar link 52A for attachment.

It is understood that the preceding description is given merely by way of illustration and not in limitation of the invention and that various modifications may be made thereto without departing from the spirit of the invention as claimed.

What is claimed is:

1. A linear actuated screw drive device powered by an electric motor for operating a universal three-point hitch device that removably attaches to small working vehicles and raises and lowers attachment implements, the device comprising:
a three-point universal hitch and a pivotable means of attaching the universal hitch to a working vehicle, a linear actuating mechanism having a screw drive, an electric motor powering the screw drive, a means for receiving working implements attachable to the three-point universal hitch in such a way that the device provides a range of controllable forces that push and pull, raise and lower and create a range of motions for various attached working implements used in various applications.

2. The device of claim 1 wherein the pivotable means of attaching the device to a work vehicle comprises at least one or more pins removably insertable through mating openings in the device and the work vehicle so that the device may be attached to and removed from the work vehicle as desired.

3. The device of claim 2 wherein the device is structured to attach removably to any of a number of work vehicles taken from a list of work vehicles including small tractors, rider mowers, RTVs, ATVs, garden tractors, small four wheeled vehicles, and rigid platforms.

4. The device of claim 1 wherein the electric powered screw is attached to a box scraper comprising a mount for attachment to a small working vehicle, the mount having a means for attaching other work elements to the box scraper, the electric powered screw raising and lowering the scraper and any other attached work tool, a box scraper control for the electric powered screw, the box scraper control wired to an electrical system of the small working vehicle for power, a first scraper blade attached horizontally across the box scraper which cuts when the working vehicle is moving in a forward direction, a pair of side panels for holding removed material in a position in front of the first scraper blade to retain and relocate removed material, a second scraper blade attached horizontally across the box scraper, the second scraper blade facing in an opposite direction to the first scraper blade so that the second scraper blade will cut when the working vehicle is moving in a reverse direction to dig and pile up material, an adjustment bar on the box scraper for adjusting the scraper blades to different angles to a surface being worked, a second electric motor and second drive screw attached to the adjustment bar for actuating the scraper blades in an upward and downward controlled force.

5. The device of claim 4 wherein the box scraper control comprises a three position switch causing the screw to actuate to raise or lower the mount and automatically return the switch to a neutral position.

6. The device of claim 4 further comprising manual adjustments on the mount to allow different attachments to the mount when hooking up to other attached work elements.

7. The device of claim 4 wherein one of the other work elements comprises a ripper bar attached horizontally to the box scraper with a series of prongs attached along a length of the ripper bar so that the series of prongs are used for digging in a lowered position.
